(19) United States
(12) Patent Application Publication
(10) Pub. No.: US 2015/0195612 A1
(43) Pub. Date: Jul. 9, 2015

(54) AUDIO BROADCASTING APPARATUS, MULTIMEDIA AV BROADCASTING SYSTEM AND METHOD THEREOF

(71) Applicants: LITE-ON TECHNOLOGY CORPORATION, TAIPEI CITY (TW); LITE-ON ELECTRONICS (GUANGZHOU) LIMITED, GUANGZHOU (CN)

(72) Inventors: MENG-YUAN LIU, NEW TAIPEI CITY (TW); CHIH-WEN TU, NEW TAIPEI CITY (TW)

(73) Assignees: LITE-ON TECHNOLOGY CORPORATION, TAIPEI CITY (TW); LITE-ON ELECTRONICS (GUANGZHOU) LIMITED, GUANGZHOU (CN)

(21) Appl. No.: 14/189,286

(22) Filed: Feb. 25, 2014

(30) Foreign Application Priority Data
Jan. 3, 2014 (CN) 201410005497.6

(51) Int. Cl. H04N 21/4363; H04N 21/439; H04N 21/436; H04N 21/434; H04W 4/00; H04N 21/41

(52) U.S. Cl. CPC H04N 21/43637; H04W 4/008; H04N 21/4126; H04N 21/43615; H04N 21/43635; H04N 21/4341; H04N 21/4398

(57) ABSTRACT

An audio broadcasting apparatus used for broadcasting an audio signal is illustrated. There is a first multimedia channel existing between the audio broadcasting apparatus and a mobile apparatus, and there is a second multimedia channel existing between the audio broadcasting apparatus and a video displayer. The audio broadcasting apparatus includes an antenna, a wireless receiving unit, a multimedia processing unit, an AV transceiver, an audio processing unit and a speaker. The wireless receiving unit receives multimedia stream data transmitted by the mobile apparatus via the antenna. The multimedia processing unit separates the multimedia stream data into a video stream data and an audio stream data. The AV transceiver transmits the video stream data to the video displayer for broadcasting video, and the audio processing unit receives and decodes the audio stream data and then transmits the audio stream data decoded to the speaker for broadcasting audio signal.

### BACKGROUND

1. Technical Field

The present disclosure relates to audio broadcasting apparatus, multimedia AV broadcasting system and method thereof; in particular, to an audio broadcasting apparatus, multimedia AV broadcasting system and method thereof of wirelessly receives multimedia stream data transmitted by the mobile apparatus and play.

2. Description of Related Art

In recent years, due to the popularity of large-size LCD TVs, and the LCD TVs trends toward thinner and characteristics of the LCD TVs hang on the wall, causing the sound effect of the LCD TVs as expected. Therefore, audio manufacturers have launched a production sound bar which type of long-type speakers to use with the large LCD screen for improving the listening experience when watching TV. In addition, the design of the sound bar, the front speakers will naturally be on the same horizontal plane; for the position, sounds of the single sound bar for the lateral distribution with the large-size LCD TV screen is the same, compared with the general speakers on both sides built-in the LCD TV, the products of sound bar can have better sound performance.

In prior art, with the popularity of wireless video streaming technology, consumers have a lot of demand with audio and video data within the handheld device wireless streams to the TV. However, currently on the market regards the wireless audio playback device with TVs (e.g. Sound Bar), generally only accepts the audio source from the TV or the audio source with wireless streaming to handheld devices, and can not receive wireless video data.

### SUMMARY

The instant disclosure provides an audio broadcasting apparatus used for broadcasting an audio signal. There is a first multimedia channel existing between the audio broadcasting apparatus and a mobile apparatus, and there is a second multimedia channel existing between the audio broadcasting apparatus and a video displayer. The audio broadcasting apparatus includes an antenna, a wireless receiving unit, a multimedia processing unit, an AV transceiver, an audio processing unit and a speaker. The wireless receiving unit receives a multimedia stream data transmitted by the mobile apparatus via the antenna, wherein the first multimedia channel exists between the antenna and the mobile apparatus. The multimedia processing unit is electrically connected to the wireless receiving unit. The multimedia processing unit is configured to operatively receive the multimedia stream data and then separating the multimedia stream data into a video stream data and an audio stream data. The AV transceiver is electrically connected to the multimedia processing unit. The AV transceiver is configured to operatively receive the video stream data and then transmitting the video stream data to the video displayer for broadcasting video via the second multimedia channel. The audio processing unit is electrically connected to the multimedia processing unit. The audio processing unit is configured to operatively receive the audio stream data and then decoding the audio stream data, and transmitting the audio stream data decoded to the speaker for broadcasting audio signal.

In an embodiment of the instant disclosure, the audio broadcasting apparatus further includes an audio amplifying unit. The audio amplifying unit is electrically connected between the audio processing unit and the speaker. The audio amplifying unit is configured to operatively amplify the power of the audio stream data decoded.

In an embodiment of the instant disclosure, the audio broadcasting apparatus further includes a connector. The connector is electrically connected between the AV transceiver and the video displayer, wherein the AV transceiver is a high definition multimedia AV transceiver and the video displayer is a high definition multimedia interface (HDMI).

In an embodiment of the instant disclosure, the communication protocol of the wireless receiver unit is the Bluetooth communication protocol standards or Wi-Fi (IEEE 820.11 series) communication protocol standards.

The instant disclosure provides a multimedia AV broadcasting system. The multimedia AV broadcasting system includes a mobile apparatus, an audio broadcasting apparatus and a video displayer. The mobile apparatus transmits a multimedia stream data. The audio broadcasting apparatus wirelessly connects to the mobile apparatus via the first multimedia channel. The audio broadcasting apparatus receives the multimedia stream data, and then separates the multimedia stream data into a video stream data and an audio stream data, wherein the audio broadcasting apparatus broadcasts the audio stream data via the speaker. The video displayer connects to the audio broadcasting apparatus for receiving the video stream data via the second multimedia channel so as to broadcast video.

The instant disclosure provides a multimedia AV broadcasting method of an audio broadcasting apparatus. There is a first multimedia channel existing between the audio broadcasting apparatus and a mobile apparatus, and there is a second multimedia channel existing between the audio broadcasting apparatus and a video displayer. The audio broadcasting apparatus includes an antenna, a wireless receiving unit, a multimedia processing unit, an AV transceiver, an audio processing unit and a speaker. The wireless receiving unit wirelessly connects to the mobile apparatus, the multimedia processing unit electrically connects to the wireless receiving unit, the AV transceiver electrically connects to the multimedia processing unit and the video displayer, the audio processing unit electrically connects to the multimedia processing unit and the speaker. The multimedia AV broadcasting method may have the steps of wirelessly receiving a multimedia stream data transmitted by the mobile apparatus via the antenna to the wireless receiving unit, wherein the first multimedia channel exists between the antenna and the mobile apparatus; receiving the multimedia stream data and then separating the multimedia stream data into a video stream data and an audio stream data by the multimedia processing unit; transmitting the video stream data to the video displayer for broadcasting video by the AV transceiver via the second multimedia channel; and receiving the audio stream data and then decoding the audio stream data, and transmitting the audio stream data decoded to the speaker for broadcasting audio by the audio processing unit.

To sum up, an exemplary embodiment of the present disclosure provides an audio broadcasting apparatus, a multimedia AV broadcasting system and method thereof. The multimedia processing unit is used to separate the multimedia stream data into the video stream data and the audio stream data, and respectively transmitting the video stream data and the audio stream data to the video display and the speaker. Thereby, installation way is simplified when consumers is in the use of the wireless video streaming. To achieve better viewing and listening experience.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of an audio broadcasting apparatus according to an exemplary embodiment of the instant disclosure.

FIG. 2 is a block diagram of an audio broadcasting apparatus according to another exemplary embodiment of the instant disclosure.

FIG. 3 is a block diagram of a multimedia AV broadcasting system according to exemplary embodiment of the instant disclosure.

FIG. 4 is a flow diagram of a multimedia AV broadcasting method thereof according to exemplary embodiment of the instant disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the present disclosure. As used herein, the term “and/or” includes any and all combinations of one or more of the associated listed items.

[Embodiment of an Audio Broadcasting Apparatus]

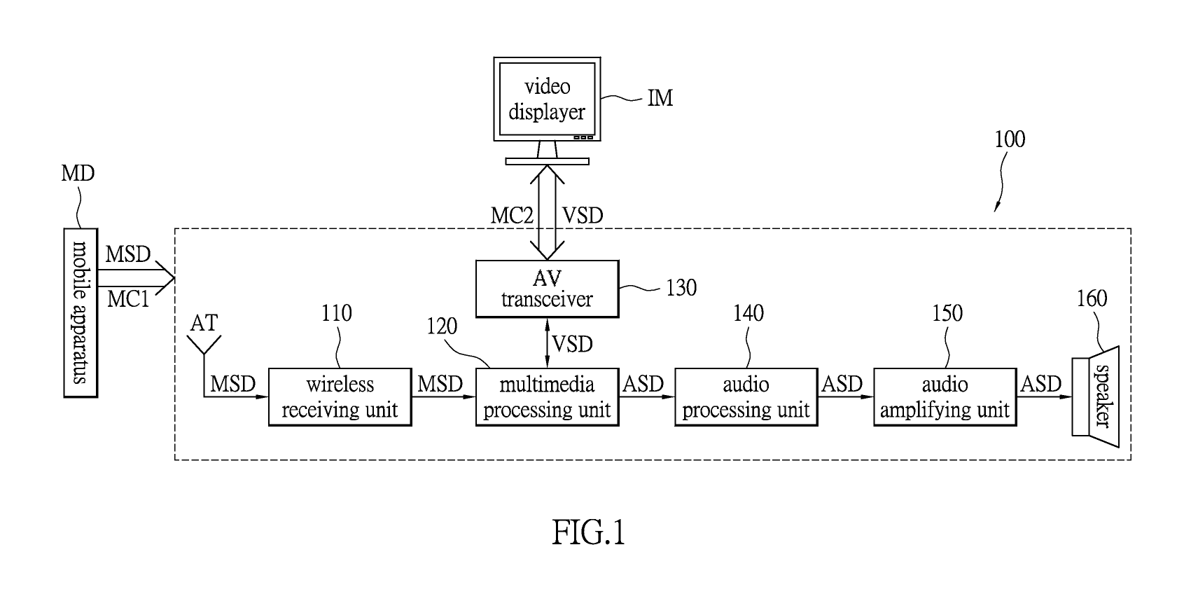

Please refer to FIG. 1, FIG. 1 is a block diagram of an audio broadcasting apparatus according to an exemplary embodiment of the instant disclosure. As shown in FIG. 1, an audio broadcasting apparatus 100 may be a sound bar. The audio broadcasting apparatus 100 includes an antenna AT, a wireless receiving unit 110, a multimedia processing unit 120, an AV transceiver 130, an audio processing unit 140, an audio amplifying unit 150 and a speaker 160. In the present embodiment, there is a first multimedia channel MC1 existing between the audio broadcasting apparatus 100 and a mobile apparatus MD, and there is a second multimedia channel MC2 existing between the audio broadcasting apparatus 100 and a video displayer IM. It is worth to be mentioned that the first multimedia channel MC1 of the instant disclosure is a wireless communication channel. The multimedia processing unit 120 is electrically connected between the wireless receiving unit 110 and the AV transceiver 130. The audio processing unit 140 is electrically connected to the multimedia processing unit 120. The audio amplifying unit 150 is electrically connected between the audio processing unit 140 and the speaker 160. In the present embodiment, the video displayer IM may be an OLED (Organic Light Emitting Diode) displayer, a LED (Light Emitting Diode) displayer, a LCD (Liquid Crystal Display) or a plasma displayer.

Regarding the wireless receiving unit 110, the wireless receiving unit 110 receives a multimedia stream data MSD transmitted by the mobile apparatus MD via the antenna AT, wherein the first multimedia channel MC1 exists between the antenna AT and the mobile apparatus MD, and the implement method of the antenna AT is not restricted the instant disclosure. Moreover, the wireless receiving unit 110 may be a Bluetooth module or a Wi-Fi (IEEE 820.11 series) module; which means, the communication protocol of the wireless receiving unit 110 is the Bluetooth communication protocol standards or Wi-Fi (IEEE 820.11 series) communication protocol standards. In addition, the mobile apparatus MD may be a smart phone, a tablet or a notebook.

Regarding the multimedia processing unit 120, the multimedia processing unit 120 is configured to operatively receive the multimedia stream data MSD and then separating the multimedia stream data MSD into a video stream data VSD and an audio stream data ASD. Afterwards, the multimedia processing unit 120 transmits the video stream data VSD to the video displayer IM so as to broadcast video (or image), and the multimedia processing unit 120 transmits the audio stream data ASD to the speaker 160 in the audio broadcasting apparatus 100 for broadcasting audio (or music).

Regarding the AV transceiver 130, the AV transceiver 130 is configured to operatively receive the video stream data VSD and then transmitting the video stream data VSD to the video displayer IM for broadcasting video via the second multimedia channel MC2. Furthermore, the AV transceiver 130 may be communicated with the video displayer IM by means of wired or wireless connection.

Regarding the audio processing unit 140, the audio processing unit 140 is configured to operatively receive the audio stream data ASD and then decoding the audio stream data ASD, and transmitting the audio stream data ASD decoded to the speaker 160 via the audio amplifying unit 150 for broadcasting audio (or music).

Regarding the audio amplifying unit 150, the audio amplifying unit 150 is configured to operatively amplify the power of the audio stream data ASD decoded.

In the following description is further instruction in teaching a work mechanism of the audio broadcasting apparatus 100.

When the user desires to transmit the multimedia AV files of the mobile apparatus MD to the video displayer IM for viewing, the user will be able to separate the multimedia AV files into a video signal and an audio signal via the audio broadcasting apparatus 100 of the instant disclosure so as to transmit the video signal of the multimedia AV files to the video displayer IM for viewing video, and broadcast the audio signal of the multimedia AV files via the speaker 160 in the audio broadcasting apparatus 100. Thereby, installation way that users utilize the wireless video streaming of the instant disclosure is simplified, and better viewing and listening experience are achieved.

In detail, when the mobile apparatus MD operated by users transmits the multimedia stream data MSD via the first multimedia channel MC1 to the antenna AT of the audio broadcasting apparatus 100, the wireless receiving unit 110 receives the multimedia stream data MSD via the antenna AT. Next, the wireless receiving unit 110 transmits the multimedia stream data MSD to the multimedia processing unit 120. Afterwards, the multimedia processing unit 120 separates the multimedia stream data MSD received into the video stream data VSD and the audio stream data ASD. Regarding subsequent processing for the video stream data VSD, the multimedia processing unit 120 transmits the video stream data VSD to the AV transceiver 130. After that, the AV transceiver 130 transmits the video stream data VSD to the video displayer IM for broadcasting video via the second multimedia channel MC2, and thus the users is able to view the image of the screen of the multimedia AV files, wherein the second multimedia channel MC2 of the present embodiment is a wireless communication channel. That is, the AV transceiver 130 wirelessly transmits the video stream data VSD to the video displayer IM. In the other hand, regarding the audio stream data ASD, the multimedia processing unit 120 transmits the audio stream data ASD to the audio processing unit 140 for decoding or related signal processing, and the audio processing unit 140 transmits the audio stream data ASD decoded to the audio amplifying unit 150. In the present embodiment, the audio amplifying unit 150 is configured to amplify the power of the audio stream data ASD decoded and transmitting the audio stream data ASD to the speaker for broadcasting audio, thereby allowing the users to listen to surround audio with good quality.

For specific instruction of an operation flow of the audio broadcasting apparatus 100 of the instant disclosure, there is at least one embodiment recited below for further instruction.

In the following embodiments, there are only parts different from embodiments in FIG. 1 described, and the omitted parts are indicated to be identical to the embodiments in FIG. 1. In addition, for an easy instruction, similar reference numbers or symbols refer to elements alike.

[Another Embodiment of the Audio Broadcasting Apparatus]

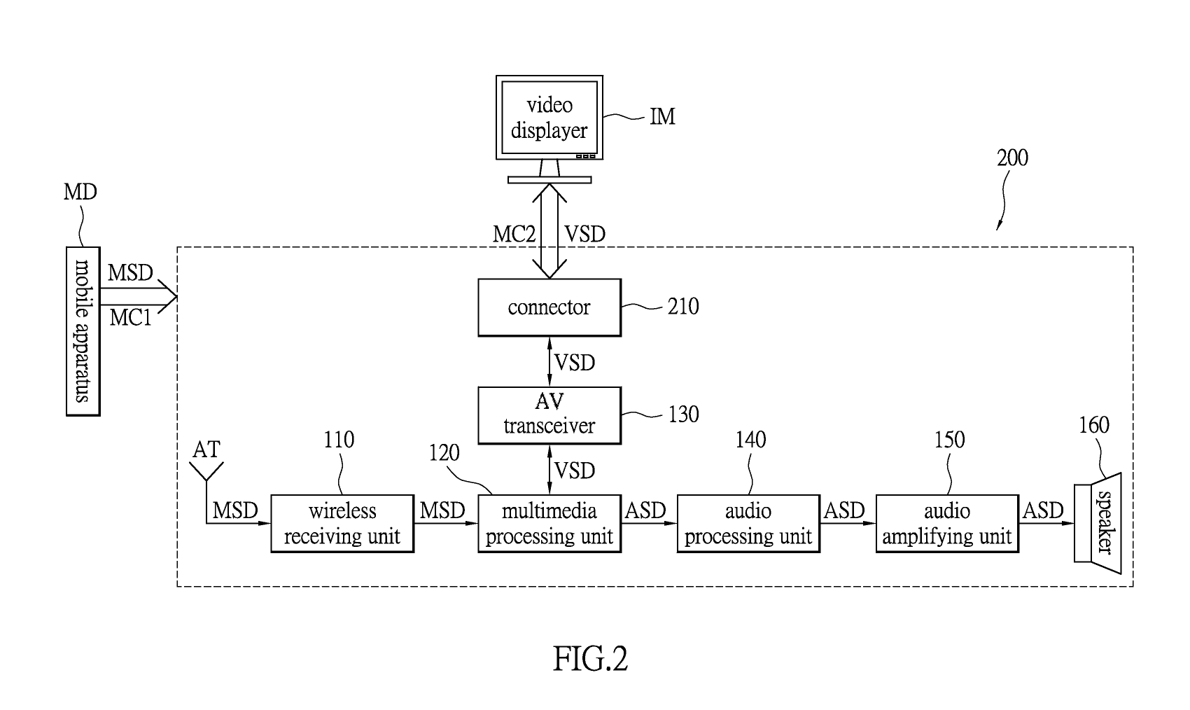

Please refer to FIG. 2, FIG. 2 is a block diagram of an audio broadcasting apparatus according to another exemplary embodiment of the instant disclosure. As shown in FIG. 2, difference from above-mentioned embodiment in FIG. 1 is that the audio broadcasting apparatus 200 (may be a sound bar) further includes a connector 210. The connector 210 is electrically connected between the AV transceiver 130 and the video displayer IM. In short, the audio broadcasting apparatus 220 is electrically connected to the video displayer IM by means of wired connection, therefore the second multimedia channel MC2 of the instant disclosure is a wired communication channel. It is to be noted that, in the present embodiment, the AV transceiver 130 is a high resolution multimedia AV transceiver, and the connector 210 is a high definition multimedia interface (HDMI). The high definition multimedia interface may provide data transfer bandwidth up to 5 Gbps and may transmit audio signals (or music) and high resolution video signals (or image) without compression. The benefits of applying the high definition multimedia interface (HDMI) includes: only one HDMI cable may transmit audio (or music) and video (or image) simultaneously without connecting multiple cables for transmitting now. For consumers, the HDMI technology not only provides a quality of clear picture, and greatly simplifies the installation of a home theater system due to the same cable by audio and video using.

In the following description is further instruction in teaching a work mechanism of the audio broadcasting apparatus 200.

Similarly, when the mobile apparatus MD operated by users transmits the multimedia stream data MSD via the first multimedia channel MC1 to the antenna AT of the audio broadcasting apparatus 200, the wireless receiving unit 110 receives the multimedia stream data MSD via the antenna AT. Next, the wireless receiving unit 110 transmits the multimedia stream data MSD to the multimedia processing unit 120. Afterwards, the multimedia processing unit 120 separates the multimedia stream data MSD received into the video stream data VSD and the audio stream data ASD. Regarding subsequent processing for the video stream data VSD, the multimedia processing unit 120 transmits the video stream data VSD to the AV transceiver 130. Afterwards, the AV transceiver 130 transmits the video stream data VSD to the connector 210, and the connector 210 transmits the video stream data VSD to the video displayer IM for broadcasting video via the second multimedia channel MC2 (wired form), and thus the users is able to view the image of the screen of the multimedia AV files, wherein the second multimedia channel MC2 of the present embodiment is a wired communication channel. In the other hand, regarding the audio stream data ASD is similar to the above-mentioned embodiment in FIG. 1, and thus it is not repeated thereto.

Additionally, in one embodiment, when the video displayer IM broadcasts analog TV programs or a digital TV programs, the video displayer IM (e.g., LCD displayer) transmits the audio signals (or music) to the audio broadcasting apparatus 200 so as to broadcast the audio signals (or music). That is, the video displayer IM transmits the audio signals to the connector 210, the AV transceiver 130 and the multimedia processing unit 120 via the cable by means of wired connection. After that, the multimedia processing unit 120 transmits the audio signals to the speaker 160 via the audio processing unit 140 and the audio amplifying unit 150 for broadcasting audio (or music).

[Embodiment of a Multimedia AV Broadcasting System]

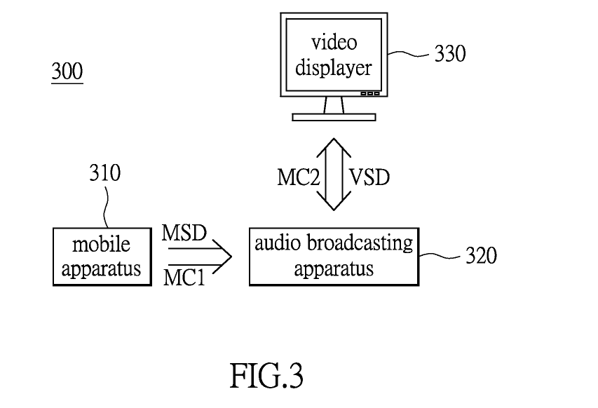

Please refer to FIG. 3, FIG. 3 is a block diagram of a multimedia AV broadcasting system according to exemplary embodiment of the instant disclosure. As shown in FIG. 3, the multimedia AV broadcasting system 300 includes a mobile apparatus 310, an audio broadcasting apparatus 320 (may be a sound bar) and a video displayer 330. The mobile apparatus 310 is wirelessly connected to the audio broadcasting apparatus 320, and the audio broadcasting apparatus 320 is connected to the video displayer 330 (by means of wired or wireless connection). The mobile apparatus 310 transmits the multimedia stream data MSD. The audio broadcasting apparatus 320 is wirelessly connected to the mobile apparatus 310 via the first multimedia channel MC1, and the audio broadcasting apparatus 320 is connected to the video displayer 330 via the second multimedia channel MC2 by means of wired or wireless connection. The audio broadcasting apparatus 320 receives the multimedia stream data MSD, and then separates the multimedia stream data MSD into a video stream data VSD and an audio stream data ASD (not shown in FIG. 3), wherein the audio broadcasting apparatus 320 broadcasts the audio stream data ASD via the speaker (not shown in FIG. 3). It is worth to be mentioned that the audio broadcasting apparatus 320 may be one of the audio broadcasting apparatus 100 or 200 by the above-mentioned embodiment.

[Embodiment of a Multimedia AV Broadcasting Method Thereof]

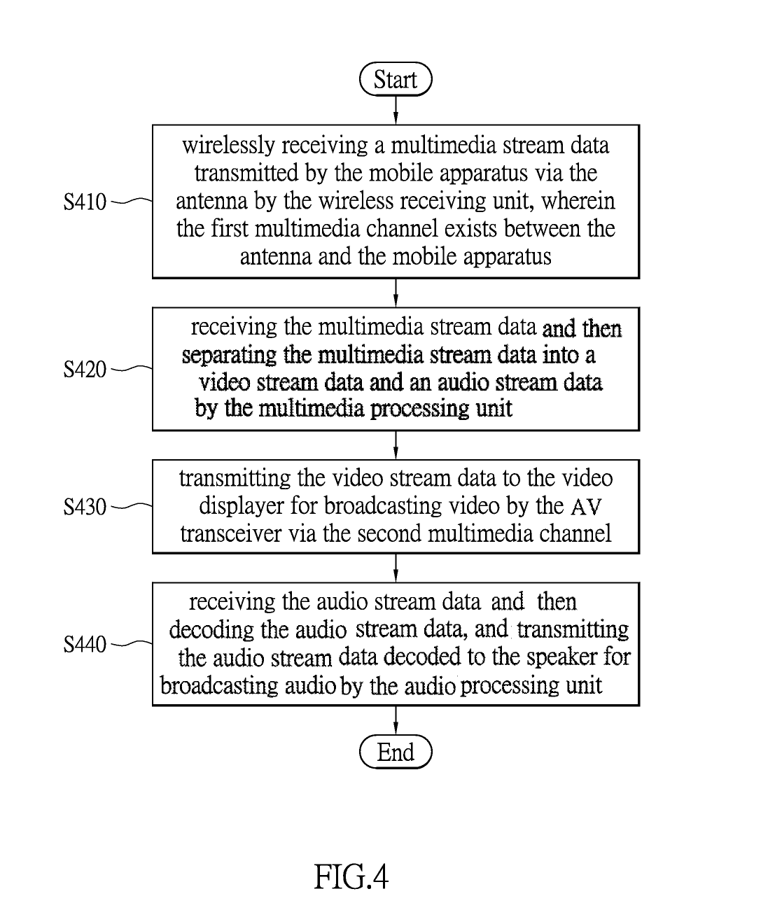

Please refer to FIG. 4, FIG. 4 is a flow diagram of a multimedia AV broadcasting method according to exemplary embodiment of the instant disclosure. The method of the present embodiment may be implemented in the audio broadcasting apparatus 100 or 200 (the audio broadcasting apparatus 100 or 200 may be a sound bar) shown in FIG. 1 or 2, and thus please refer to FIGS. 1 and 2 for further understanding. The multimedia AV broadcasting method comprises steps as follows: wirelessly receiving a multimedia stream data transmitted by the mobile apparatus via the antenna by the wireless receiving unit, wherein the first multimedia channel exists between the antenna and the mobile apparatus (Step S410); receiving the multimedia stream data and then separating the multimedia stream data into a video stream data and an audio stream data by the multimedia processing unit (Step S420); transmitting the video stream data to the video displayer for broadcasting video by the AV transceiver via the second multimedia channel (Step S430); and receiving the audio stream data and then decoding the audio stream data, and transmitting the audio stream data decoded to the speaker for broadcasting audio by the audio processing unit (Step S440).

Relevant details of the steps of the multimedia AV broadcasting method regarding the multimedia AV broadcasting system are described in the embodiments of FIGS. 1-3, and thus it is not repeated thereto. It is clarified that, a sequence of steps in FIG. 4 is set for a need to instruct easily, and thus the sequence of the steps is not used as a condition in demonstrating the embodiments of the instant disclosure.

In summary, an exemplary embodiment of the present disclosure provides an audio broadcasting apparatus, a multimedia AV broadcasting system and method thereof. The multimedia processing unit is used to separate the multimedia stream data into the video stream data and the audio stream data, and respectively transmitting the video stream data and the audio stream data to the video display and the speaker. Thereby, installation way is simplified when consumers is in the use of the wireless video streaming. To achieve better viewing and listening experience.

The instant disclosure can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An audio broadcasting apparatus, having a first multimedia channel existing between the audio broadcasting apparatus and a mobile apparatus, and having a second multimedia channel existing between the audio broadcasting apparatus and a video displayer, and the audio broadcasting apparatus comprising:
an antenna;
a wireless receiving unit, wirelessly receiving a multimedia stream data transmitted by the mobile apparatus via the antenna, wherein the first multimedia channel exists between the antenna and the mobile apparatus;
a multimedia processing unit, electrically connected to the wireless receiving unit, configured to receive the multimedia stream data and then separating the multimedia stream data into a video stream data and an audio stream data;
an AV transceiver, electrically connected to the multimedia processing unit, configured to receive the video stream data and then transmitting the video stream data to the video displayer for broadcasting video via the second multimedia channel;
an audio processing unit electrically connected to the multimedia processing unit, configured to receive the audio stream data and decoding the audio stream data; and
a speaker, receiving the audio stream data decoded for broadcasting audio.

2. The audio broadcasting apparatus according to claim 1, further comprising:
an audio amplifying unit, electrically connected between the audio processing unit and the speaker, configured to amplify the power of the audio stream data decoded.

3. The audio broadcasting apparatus according to claim 1, further comprising:
a connector, electrically connected between the AV transceiver and the video displayer, wherein the AV transceiver is a high definition multimedia AV transceiver and the connector is a high definition multimedia interface (HDMI).

4. The audio broadcasting apparatus according to claim 1, wherein the communication protocol of the wireless receiver unit is the Bluetooth communication protocol standards or Wi-Fi (IEEE 820.11 series) communication protocol standards.

5. A multimedia AV broadcasting system, comprising:
a mobile apparatus, transmitting a multimedia stream data;
an audio broadcasting apparatus, comprising a speaker, the audio broadcasting apparatus wirelessly connected to the mobile apparatus for receiving the multimedia stream data via a first multimedia channel, and then separating the multimedia stream data into a video stream data and an audio stream data, wherein the audio broadcasting apparatus broadcasts the audio stream data via the speaker; and
a video displayer, connected to the audio broadcasting apparatus for receiving the video stream data via the second multimedia channel so as to broadcast video.

6. A multimedia AV broadcasting system according to claim 5, wherein the audio broadcasting apparatus further comprising:
an antenna;
a wireless receiving unit, wirelessly receiving the multimedia stream data transmitted by the mobile apparatus via the antenna, wherein the first multimedia channel exists between the antenna and the mobile apparatus;
a multimedia processing unit, electrically connected to the wireless receiving unit, configured to receive the multimedia stream data and then separating the multimedia stream data into a video stream data and an audio stream data;
an AV transceiver, electrically connected to the multimedia processing unit, configured to receive the video stream data and then transmitting the video stream data to the video displayer for broadcasting video via the second multimedia channel; and
an audio processing unit, electrically connected to the multimedia processing unit, configured to receive the audio stream data and then decoding the audio stream data, wherein the audio processing unit transmits the audio stream data decoded to the speaker for broadcasting audio.

7. A multimedia AV broadcasting system according to claim 6, wherein the audio broadcasting apparatus further comprises:
an audio amplifying unit, electrically connected between the audio processing unit and the speaker, the audio amplifying unit configured to amplify the power of the audio stream data decoded.

8. A multimedia AV broadcasting system according to claim 6, wherein the audio broadcasting apparatus further comprises:
a connector, electrically connected between the AV transceiver and the video displayer, wherein the AV transceiver is a high definition multimedia AV transceiver and the connector is a high definition multimedia interface (HDMI).

9. A multimedia AV broadcasting system according to claim 6, wherein the communication protocol of the wireless receiver unit is the Bluetooth communication protocol standards or Wi-Fi (IEEE 820.11 series) communication protocol standards.

10. A multimedia AV broadcasting method used for an audio broadcasting apparatus, the audio broadcasting apparatus having a first multimedia channel existing between the audio broadcasting apparatus and a mobile apparatus and having a second multimedia channel existing between the audio broadcasting apparatus and a video displayer, and the audio broadcasting apparatus comprising an antenna, a wireless receiving unit, a multimedia processing unit, an AV transceiver, an audio processing unit, and a speaker, wherein the wireless receiving unit is wirelessly connected to the mobile apparatus, the multimedia processing unit is electrically connected to the wireless receiving unit, the AV transceiver is electrically connected to the multimedia processing unit and the video displayer, the audio processing unit is electrically connected to the multimedia processing unit and the speaker, the multimedia AV broadcasting method comprising:
wirelessly receiving a multimedia stream data transmitted by the mobile apparatus via the antenna by the wireless receiving unit, wherein the first multimedia channel exists between the antenna and the mobile apparatus;
receiving the multimedia stream data and then separating the multimedia stream data into a video stream data and an audio stream data by the multimedia processing unit;
transmitting the video stream data to the video displayer for broadcasting video by the AV transceiver via the second multimedia channel; and
receiving the audio stream data and then decoding the audio stream data, and transmitting the audio stream data decoded to the speaker for broadcasting audio by the audio processing unit.

11. A multimedia AV broadcasting method according to claim 10, wherein the audio broadcasting apparatus further comprises:
an audio amplifying unit, electrically connected between the audio processing unit and the speaker, the audio amplifying unit configured to amplify the power of the audio stream data decoded.

12. A multimedia AV broadcasting method according to claim 10, wherein the audio broadcasting apparatus further comprises:
a connector, electrically connected between the AV transceiver and the video displayer, wherein the AV transceiver is a high definition multimedia AV transceiver and the connector is a high definition multimedia interface (HDMI).
